(19) United States
(12) Patent Application Publication
(10) Pub. No.: US 2026/0215428 A1
(43) Pub. Date: Jul. 30, 2026

(54) WEED CONTROL METHOD

(71) Applicant: SYNGENTA CROP PROTECTION AG, Basel (CH)

(72) Inventors: Sarah Jane DAVIS, Bracknell, Berkshire (GB); Shiv Shankhar KAUNDUN, Bracknell, Berkshire (GB)

(73) Assignee: SYNGENTA CROP PROTECTION AG, Basel (CH)

(21) Appl. No.: 19/145,615

(22) PCT Filed: Jan. 2, 2024
(86) PCT No.: PCT/EP2024/050015

§ 371 Date: Jul. 3, 2025

(30) Foreign Application Priority Data
Jan. 5, 2023 (EP) 23150401.0

(51) Int. Cl. A01N 47/06; A01N 35/06; A01N 37/42; A01P 13/02

(52) U.S. Cl. CPC A01N 47/06; A01N 35/06; A01N 37/42; A01P 13/02

(57) ABSTRACT

The present invention relates to a method of controlling the growth of monocotyledonous weeds that are resistant to an ACCase-inhibiting herbicide other than a compound of Formula (I) at a locus, said method comprising applying to the locus a herbicide composition comprising a compound of Formula (I).

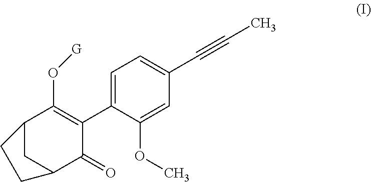

Herbicides which inhibit acetyl-CoA carboxylase (ACCase) were introduced in the mid-1970s and are now widely used to control grass (monocotyledonous) weeds in many crops including, for example, small-grain cereal crops and rice as well as dicotyledonous crops, such as soybean. Given their convenience for managing grass weeds post-emergence, ACCase-inhibiting herbicides (ACCase herbicides) were quickly adopted as they provided a marked improvement over the then commonly used method of selective grass weed control. Over time, however, extensive and recurrent use of ACCase herbicides has selected for resistance in key grass weed species and resistance to ACCase herbicides is now documented in numerous grass weeds and is particularly problematic in Lolium, Alopecurus and Avena species.

Accordingly, there exists a need to provide further agricultural methods that can provide sufficient control of these problematic monocotyledonous weeds that are resistant to ACCase-inhibiting herbicides (ACCase-resistant weeds) that are currently available. Surprisingly, it has now been found that certain ACCase herbicides provide exceptionally good control of such ACCase-resistant weeds. Thus, according to the present invention there is provided a method of controlling the growth of monocotyledonous weeds that are resistant to an ACCase-inhibiting herbicide other than a compound of Formula (I) at a locus, said method comprising applying to the locus a herbicide composition comprising a compound of Formula (I)

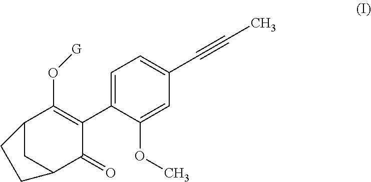

wherein G is selected from the group consisting of hydrogen, —C(O)CH₃ and —C(O)OCH₃.

Compounds of Formula (I) are known from WO2015/197468. In a preferred embodiment of the present invention the compound of Formula (I) is selected from the group consisting of Formula (Ia), (Ib) and (Ic).

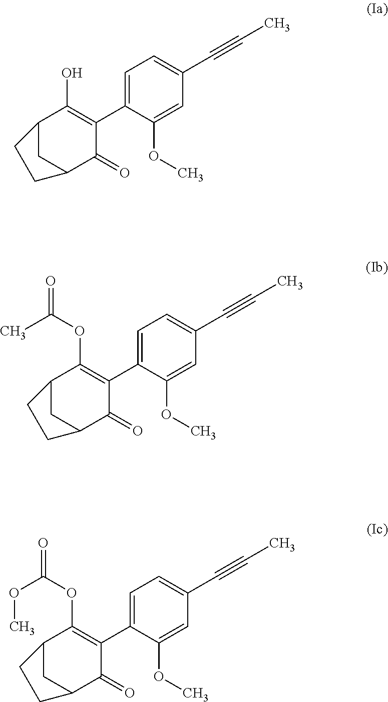

In one embodiment of the present invention the compound of Formula (I) is a compound of Formula (Ia), including agrochemically acceptable salts thereof. In another embodiment of the present invention the compound of Formula (I) is a compound of Formula (Ib). In another embodiment of the present invention the compound of Formula (I) is a compound of Formula (Ic).

The term “locus” is simply taken to mean a location where the ACCase-resistant monocotyledonous weeds are present. Examples include gardens, pathways, railway tracks but more often the locus will be a crop cultivation area, for example a field. For the avoidance of doubt it should be understood that the locus can further comprise other weeds, including those susceptible to ACCase herbicides. Where the locus is a crop cultivation area the methods of the present invention have broad utility in the control monocotyledonous ACCase-resistant weeds in a wide variety of crop plants. For example, the herbicide composition can be applied pre-planting (before the crop is planted in the field) to control monocotyledonous ACCase-resistant weeds in a wide range of crops that are planted subsequently at the locus, including, for example, corn, cereal, cotton and soybean crops. It should be understood that the crop plant may optionally comprise a herbicide tolerance and/or insect tolerance and/or nematode tolerance trait. Furthermore, it should be appreciated that some dicotyledonous crops plants are inherently resistant to the compounds of Formula (I) and thus in this situation it is possible for the herbicide compositions to be applied whilst the crop plant is present at the locus. Such application may be made pre-emergence (where the crop has been planted at the locus but not yet emerged) or post-emergence (or “over-the-top” where the crop has emerged at the locus). It should be appreciated that a combination of pre-plant, pre-emergent and post-emergent applications are utilised, depending on the particular needs of the grower.

Thus, in a preferred embodiment of the present invention there is provided a method wherein the locus further comprises a dicotyledonous crop plant and wherein said method selectively controls the growth of the ACCase-resistant monocotyledonous weeds at the locus. Examples of such dicotyledonous crop plants include canola, cotton, sugar beet and sunflower as well as legumes, such as soybeans, peanuts, peas, beans and pulses such as chickpeas and lentil. Soybean is particularly preferred, including genetically modified soybean such as Liberty Link® Soybeans (A2704-12/ACS-GM005-3, A5547-127/ACS-GM006-4); RoundUp Ready® Soybeans (GTS 40-3-2); Roundup Ready 2 Yield® Soybeans (MON89788); Roundup Ready™ 2 Xtend® Soybeans (MON87708); XtendFlex® Soybeans (MON87708xMON89788xA5547-127); EnlistRE3 Soybeans (DAS44406); SYHTOH2 Soybeans (SYN-000H2-5), GMB151 Soybeans (BCS-GM151-6), FG72 Soybeans, MON94313 Soybeans and GM_CSM63714 Soybeans (WO2023/212564).

Several ACCase herbicides (HRAC Group 1) have now been commercialised to help growers tackle grass weeds and include, for example, cyclohexanediones (“Dims”) such as clethodim, cycloxydim, tepraloxydim; aryloxyphenoxy-propionates (“Fops”) such as clodinafop-propargyl, fenoxaprop-ethyl, haloxyfop-methyl, cyhalofop-butyl, fluazifop-P-butyl and quizalofop-ethyl; and “Dens” such as pinoxaden. ACCase-resistant weeds are characterised using suitable dose response comparisons. Such weeds can be divided into target- and non-target-based-mechanisms. Non-target-site-mechanisms (NTSR) are, for example, metabolism-based resistance mechanisms, which can be mediated, for example, via cytochrome p450 and/or glutathione-S-transferase metabolism. The methods of the present invention can be used to control monocotyledonous ACCase-resistant weeds which feature target-site and/or non-target site resistance and have particular utility in controlling weeds that are resistant to the ACCase herbicides clethodim and/or haloxyfop-methyl, especially clethodim.

Genetic studies have shown that resistance to ACCase herbicides can be conferred by target-site mutations within the ACCase, and the methods of the present invention are particularly suited to controlling monocotyledonous ACCase-resistant weeds featuring such target-site resistance. Target-site resistance is caused by single amino acid changes in the carboxyltransferase domain of the ACCase. Much of the early resistance work was conducted using Alopecurus myosuroides and thus the single amino acid changes, although typically conserved between species, are often characterised with regard to the plastidic Alopecurus ACCase sequence. The skilled person is well aware of sequence alignment software that can be used to identify corresponding amino acids in other species.

Thus seven different single point mutation sites have now been identified within ACCase that confer resistance: Ile1781 (11781); Typ1999 (W1999); Typ2027 (W2027); Ile2041 (I2041); Asp2078 (D2078), Cys2088 (C2088) and Gly2096 (G2096). Furthermore, at least 14 allelic variants have thus been implicated in resistance, namely I1781L/V/A/T; W1999C/L/S; W2027C; I2041N/V; D2078G, C2088R and G2096A/S. It's further understood that species can be homozygous or heterozygous for the resistance trait. It is anticipated that the compounds of Formula (I) will also be effective in controlling weeds comprising other target-site mutations within the ACCase. The skilled person will appreciate the level of resistance observed will depend on, amongst other things, the particular herbicide, recommended field rates, weed species, plant growth stages, specific amino acid changes and the number of gene copies and mutant ACCase alleles.

According to the International Herbicide-Resistant Weed Database (www.weedscience.org), as of 2022 over 250 unique cases of ACCase resistant weeds have been reported, including over 30 unique cases of clethodim-resistant weeds. These include Alopecurus sp. (e.g Alopecurus myosuroides), Avena sp. (e.g Avena fatua), Bromus sp. (e.g Bromus diandrus, Bromus rigidus, Bromus tectorum), Digitaria sp. (e.g Digitaria insularis, Digitaria sanguinalis), Ehrharta sp. (e.g Ehrharta longiflora), Echinochloa sp. (e.g Echinochloa crus-galli, Eleusine sp. (e.g Eleusine indica), Hordeum sp. (e.g Hordeum murinum ssp. leporinum), Lolium sp. (e.g Lolium rigidum, Lolium perenne, Lolium multiflorum), Phalaris sp. (e.g Phalaris minor, Phalaris paradoxa), Polypogon sp. (e.g Polypogon fugax), Sorghum sp. (e.g Sorghum halepense), Setaria sp. (e.g Setaria faberi, Setaria viridis). Thus the methods of the present invention are particularly suited to controlling these resistant weeds. In an especially preferred embodiment, the methods of the present invention are used to control ACCase resistant Digitaria insularis, Eleusine indica, Echinochloa crus-galli, Lolium perenne, Lolium multiflorum and/or Sorghum halepense in soybean. Even more preferably the methods of the present invention are used to control ACCase resistant Digitaria insularis, Eleusine indica and/or Sorghum halepense in soybean. In many soybean growing regions, in particular Latin America, clethodim is often used to control grass weeds in soybean. However, resistance to clethodim is now widely reported and is expected to grow further due to intensification and lack of alternative solutions. Methods of the present invention are particularly suited to controlling ACCase-resistant weeds, especially clethodim-resistant weeds, and especially those comprising a 11781, D2078, C2088 and/or G2096 mutation. The ACCase-resistant weeds controlled by the methods of the present invention may also be resistant to non-ACCase herbicides, for example glyphosate and/or acetolactate synthase (ALS) inhibitors.

The methods of the present invention can also be used to control ACCase-resistant “volunteer” monocotyledonous weeds especially in dicotyledonous crops such as soybean, cotton, canola, sugarbeet and sunflower. Examples of such “volunteer” monocotyledonous weeds include corn which has been engineered to be resistant to ACCase-inhibiting herbicides. For example, Enlist® Corn (DAS40278) is resistant to ACCase herbicides such as fluazifop and haloxyfop, but is readily controlled using the methods of the present invention in which compounds of Formula (I) are employed. Maize lines which are tolerant to cycloxydim and sethoxydim have also been developed via in vitro selection and feature a mutation in the plastid encoded ACCase (see for example U.S. Pat. No. 5,162,602) and such lines are also readily controlled using the methods of the present invention in which compounds of Formula (I) are employed. The “volunteer” monocotyledonous weeds e.g corn may also comprise resistance to other herbicides, such as glyphosate, glufosinate, dicamba, 2,4-D and/or protoporphyrinogen oxidase (PPO)-inhibiting herbicides.

In the methods of the present invention, the compound of Formula (I), (Ia), (Ib) or (Ic) may be applied to the locus a rate from 25 to 500 g/ai. The actual rate applied will depend on a number of considerations including, for example, the timing of application, the ACCase-resistant weed to be controlled and the growth stage etc. For pre-plant application the typical application rate could be from 25 to 500 g/ha, more preferably from 100 to 400 g/ha; for a post-emergent application the typical application rate could be from 25 to 200 g/ha. Split applications to the locus of the compound of Formula (I) are envisaged, for example 200 g/ha could be applied to the locus in a given growing season as a one-pass 200 g/ha application, or 2×100 g/ha applications etc. It should be further understood that the herbicide compositions used in the methods of the present invention may further comprise one or more additional pesticides, for example herbicides, fungicides, insecticides and/or nematicides. In a preferred embodiment of the present invention, the herbicide composition further comprises one or more herbicides selected form the group consisting of glyphosate, glufosinate (or glufosinate-P) 2,4-D, dicamba, S-metholachlor, pyroxasulfone, flumioxazin, trifludimoxazin, saflufenacil, tiafenacil or an agrochemically acceptable salts of any of the aforementioned herbicides that would be well known to the skilled person. This is particularly the case where the locus further comprises a crop plant which has been engineered to be resistant to any of these herbicides. The herbicide composition may also comprise and additional ACCase-inhibiting herbicides such as clethodim, fenoxaprop-ethyl and/or fluazifop-P-butyl. The composition may also contain adjuvants, such as Tris(2-ethylhexyl)phosphate (TEHP), methylated rape seed oil adjuvants such as Adigor® or ethoxylated sorbitan esters such as Tween®20 and Tween®80. Other tank mix adjuvants may be also be employed, such as Assist and Ochima.

The present invention further provided the use of a compound of Formula (I)

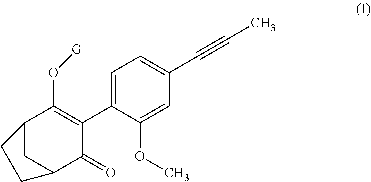

wherein G is selected from the group consisting of hydrogen, —C(O)CH₃ and —C(O)OCH₃, to control monocotyledonous weeds that are resistant to an ACCase-inhibiting herbicide other than a compound of Formula (I).

### BIOLOGICAL EXAMPLES

Seeds of a variety of test species are sown in standard soil in pots. For each treatment, three replicate pots containing 10-15 plants per one-inch pot were sprayed at the 2-3 leaf stage. Clethodim and Compound (Ic) were each applied at 15, 30, 60 and 120 g ai/ha. The test plants are then grown in a glasshouse under controlled conditions in a glasshouse (at 24/16° C., day/night; 14 hours light; 65% humidity) and watered twice daily. Plants were assessed for visual damage compared to the untreated control 14 days after application (0=0% damage; 100=100% damage).

TABLE B1-1
Lolium multiflorum

| | Rate | | Compound |
|---|---|---|---|
| Biotype* | (g/ha) | Clethodim | Ic |
| Sensitive | 15 | 53 | 100 |
| | 30 | 73 | 100 |
| | 60 | 99 | 100 |
| | 120 | 100 | 100 |
| LL1781 | 15 | 23 | 100 |
| | 30 | 37 | 100 |
| | 60 | 60 | 100 |
| | 120 | 70 | 100 |
| SS1999^{a} | 15 | 27 | 85 |
| | 30 | 98 | 100 |
| | 60 | 100 | 100 |
| | 120 | 100 | 100 |
| CC2027 | 15 | 53 | 100 |
| | 30 | 77 | 100 |
| | 60 | 100 | 100 |
| | 120 | 100 | 100 |
| NN2041 | 15 | 70 | 47 |
| | 30 | 100 | 100 |
| | 60 | 100 | 100 |
| | 120 | 100 | 100 |
| GG2078 | 15 | 0 | 40 |
| | 30 | 20 | 100 |
| | 60 | 20 | 100 |
| | 120 | 50 | 100 |
| RR2088 | 15 | 0 | 100 |
| | 30 | 20 | 100 |
| | 60 | 60 | 100 |
| | 120 | 60 | 100 |

*Homozygous lines.
^{a} 21 DAA

TABLE B1-2
Eleusine indica

| | Rate | | Compound |
|---|---|---|---|
| Biotype | (g/ha) | Clethodim | Ic |
| Sensitive | 15 | 87 | 100 |
| | 30 | 100 | 100 |
| | 60 | 100 | 100 |
| | 120 | 100 | 100 |
| **I2041N | 15 | 82 | 70 |
| | 30 | 100 | 100 |
| | 60 | 100 | 100 |
| | 120 | 100 | 100 |
| **D2078G + | 15 | 50 | 87 |
| W2027C | | | |
| | 30 | 60 | 100 |
| | 60 | 70 | 100 |
| | 120 | 80 | 100 |
| **D2078G + | 15 | 63 | 83 |
| W2027C | | | |
| | 30 | 67 | 100 |
| | 60 | 93 | 100 |
| | 120 | 100 | 100 |
| 87% **I1781L | 15 | 80 | 97 |
| | 30 | 77 | 100 |
| | 60 | 100 | 100 |
| | 120 | 100 | 100 |
| ***NTSR | 1 | 0 | 20 |
| | 2 | 33 | 40 |
| | 4 | 43 | 60 |
| | 8 | 77 | 73 |

**Heterozygous lines.
***Non-target site resistance.

TABLE B1-3
Eleusine indica

| | Rate | | Compound |
|---|---|---|---|
| Biotype | (g/ha) | Clethodim | Ic |
| Sensitive | 15 | 100 | 100 |
| | 30 | 100 | 100 |
| | 60 | 100 | 100 |
| | 120 | 100 | 100 |
| Pop1* | 15 | 10 | 98 |
| | 30 | 33 | 100 |
| | 60 | 47 | 100 |
| | 120 | 63 | 100 |
| Pop2* | 15 | 10 | 86 |
| | 30 | 33 | 100 |
| | 60 | 76 | 100 |
| | 120 | 77 | 100 |

Pop1 and Pop2 are distinct populations which comprise different proportions of sensitive, D2078G and G2096A biotypes.

TABLE B1-4
Digitaria sanguinalis

| | Rate | | Compound |
|---|---|---|---|
| Biotype | (g/ha) | Clethodim | Ic |
| Sensitive | 15 | 87 | 90 |
| | 30 | 90 | 100 |
| | 60 | 100 | 100 |
| | 120 | 100 | 100 |
| **I1781L | 15 | 20 | 73 |
| | 30 | 20 | 90 |
| | 60 | 53 | 100 |
| | 120 | 67 | 100 |

**Heterozygous lines.

TABLE B1-5
Setaria viridis

| | Rate | | Compound |
|---|---|---|---|
| Biotype | (g/ha) | Clethodim | Ic |
| Sensitive | 15 | 90 | 87 |
| | 30 | 98 | 93 |
| | 60 | 100 | 100 |
| | 120 | 100 | 100 |
| *II1781 | 15 | 80 | 70 |
| | 30 | 100 | 90 |
| | 60 | 100 | 98 |
| | 120 | 100 | 100 |
| *LL1781 | 15 | 50 | 60 |
| | 30 | 60 | 90 |
| | 60 | 60 | 98 |
| | 120 | 53 | 100 |
| *GG2078 | 15 | 30 | 50 |
| | 30 | 60 | 73 |
| | 60 | 63 | 98 |
| | 120 | 67 | 98 |

**Homozygous lines.

TABLE B1-6
Volunteer corn 26 field trials were conducted to examine the
performance of compounds of Formula (I) compared to clethodim
in controlling volunteer corn. The results are shown below.

| | Rate | Control | Control |
|---|---|---|---|
| Compound | (g/ha) | (14d) | (28d) |
| Check | 0 | 0 | 0 |
| (Untreated) | | | |
| Ic | 25 | 93 | 99 |
| | 50 | 99 | 100 |
| | 100 | 99 | 100 |
| | 200 | 99 | 100 |
| Clethodim | 100 | 90 | 96 |

Further tests were employed to test the efficacy of a compound of Formula I versus other ACCase-inhibiting herbicides. The five main targets were Lolium multiflorum, Eleusine indica, Digitaria insularis, Sorghum halepense and Echinochloa crus-galli. Collectively, the populations contained all the major target-site resistance mutations affecting ACCase herbicides. Two L. multiflorum (LM-NTSR-1 and LM-NTSR-2) and one E. crus-galli (ECG-NTSR-1) populations were characterised exclusively by non-target-site resistance (“NTSR”). The target-site resistant L. multiflorum and E. indication populations were 100% homozygous for different ACCase mutations whilst the D. insularis, S. halepense and E. crus-galli samples contained a mixture of homozygous wild and mutant individuals at different genotypic frequencies. Additional underlying NTSR cannot be ruled out in the populations characterised by target-site resistance.

Around 50 seeds of each of the 24 weed populations were sown in 12-cm pots containing a mixture of peat and compost in a 1:1 ratio. The pots were watered, fertilised and kept in controlled glasshouse conditions set at 24° C./16 hr day, 18° C. night, 65% relative humidity, and a photon flux density of approximately 250 μmol quanta m⁻² s⁻¹ for Lolium multiflorum. The E. indica, D. insularis, S. halepense and E. crus-galli plants were kept in a separate glasshouse bay characterised by a 17 H photoperiod of 180 μmol m⁻² s⁻¹ with temperatures of 25° C. day and 19° C. night and 65% relative humidity. When the plants were at the two to four-leaf stage, they were treated with the various ACCase-inhibiting herbicides at 0, 15, 30, 60, 120 and 240 g ai ha⁻¹ in a spray cabinet mounted with a single mobile Teejet flat fan nozzle (11002VS) calibrated to deliver 200 L ha⁻¹ at 200 kPa. The L. multiflorum populations were treated by a compound of Formula Ic, clodinafop-propargyl, pinoxaden, cycloxydim and clethodim and the warm season grass weeds E. indica, D. insularis, S. halepense and E. crus-galli were sprayed with a Compound Ic and the commonly employed haloxyfop-methyl and clethodim. Three replicate pots were used per population. Plants were assessed for visual damage compared to the untreated control 21 days after application (0=0% damage; 100=100% damage).

TABLE B2-1
Lolium multiflorum

| | Rate | | Clodinafop- | | | Compound |
|---|---|---|---|---|---|---|
| Biotype* | (g/ha) | Clethodim | propargyl | Cycloxydim | Pinoxaden | Ic |
| Sensitive | 15 | 100 | 67 | 0 | 100 | 100 |
| | 30 | 100 | 98 | 0 | 100 | 100 |
| | 60 | 100 | 100 | 0 | 100 | 100 |
| | 120 | 100 | 100 | 88 | 100 | 100 |
| | 240 | 100 | 100 | 100 | 100 | 100 |
| I1781L | 15 | 23 | 7 | 0 | 7 | 100 |
| | 30 | 53 | 7 | 0 | 7 | 100 |
| | 60 | 70 | 7 | 7 | 27 | 100 |
| | 120 | 100 | 10 | 13 | 73 | 100 |
| | 240 | 100 | 33 | 13 | 98 | 100 |
| W1999S | 15 | 27 | 0 | 0 | 0 | 85 |
| | 30 | 98 | 0 | 0 | 0 | 100 |
| | 60 | 100 | 0 | 0 | 0 | 100 |
| | 120 | 100 | 0 | 0 | 7 | 100 |
| | 240 | 100 | 0 | 0 | 33 | 100 |
| W2027C | 15 | 63 | 0 | 0 | 0 | 88 |
| | 30 | 100 | 0 | 0 | 10 | 100 |
| | 60 | 100 | 0 | 0 | 62 | 100 |
| | 120 | 100 | 0 | 0 | 93 | 100 |
| | 240 | 100 | 0 | 50 | 100 | 100 |
| D2078G | 15 | 10 | 0 | 0 | 3 | 20 |
| | 30 | 17 | 0 | 0 | 3 | 90 |
| | 60 | 27 | 0 | 0 | 10 | 100 |
| | 120 | 70 | 0 | 3 | 45 | 100 |
| | 240 | 100 | 0 | 7 | 90 | 100 |
| C2088R | 15 | 0 | 0 | 0 | 0 | 100 |
| | 30 | 13 | 0 | 0 | 0 | 100 |
| | 60 | 40 | 0 | 0 | 0 | 100 |
| | 120 | 90 | 0 | 0 | 3 | 100 |
| | 240 | 100 | 7 | 0 | 30 | 100 |
| LM- | 15 | 63 | 0 | 0 | 30 | 93 |
| NTSR-1 | | | | | | |
| | 30 | 97 | 0 | 0 | 85 | 100 |
| | 60 | 100 | 0 | 0 | 97 | 100 |
| | 120 | 100 | 27 | 3 | 100 | 100 |
| | 240 | 100 | 52 | 60 | 100 | 100 |
| LM- | 15 | 3 | 0 | 0 | 0 | 48 |
| NTSR-2 | | | | | | |
| | 30 | 55 | 0 | 0 | 0 | 82 |
| | 60 | 70 | 0 | 0 | 0 | 87 |
| | 120 | 75 | 0 | 0 | 65 | 100 |
| | 240 | 95 | 0 | 0 | 53 | 100 |

TABLE B2-2
Eleusine indica

| | Rate | | Haloxyfop- | Compound |
|---|---|---|---|---|
| Biotype* | (g/ha) | Clethodim | p-methyl | Ic |
| Sensitive | 15 | 92 | 100 | 100 |
| | 30 | 100 | 100 | 100 |
| | 60 | 100 | 100 | 100 |
| | 120 | 100 | 100 | 100 |
| | 240 | 100 | 100 | 100 |
| W2027C | 15 | 93 | 0 | 100 |
| | 30 | 100 | 0 | 100 |
| | 60 | 100 | 17 | 100 |
| | 120 | 100 | 30 | 100 |
| | 240 | 100 | 33 | 100 |
| I2041N | 15 | 60 | 0 | 50 |
| | 30 | 27 | 7 | 98 |
| | 60 | 53 | 0 | 100 |
| | 120 | 100 | 10 | 100 |
| | 240 | 100 | 0 | 100 |
| D2078G | 15 | 10 | 0 | 88 |
| | 30 | 27 | 0 | 100 |
| | 60 | 53 | 60 | 100 |
| | 120 | 100 | 95 | 100 |
| | 240 | 100 | 88 | 100 |
| G2096A | 15 | 7 | 3 | 93 |
| | 30 | 30 | 3 | 98 |
| | 60 | 78 | 23 | 100 |
| | 120 | 100 | 30 | 100 |
| | 240 | 100 | 53 | 100 |

TABLE B2-3
Digitaria insularis

| | Rate | | Haloxyfop- | Compound |
|---|---|---|---|---|
| Biotype* | (g/ha) | Clethodim | p-methyl | Ic |
| Sensitive | 15 | 100 | 100 | 100 |
| | 30 | 100 | 100 | 100 |
| | 60 | 100 | 100 | 100 |
| | 120 | 100 | 100 | 100 |
| | 240 | 100 | 100 | 100 |
| W2027C | 15 | 78 | 76 | 100 |
| | 30 | 100 | 53 | 100 |
| | 60 | 100 | 93 | 100 |
| | 120 | 100 | 100 | 100 |
| | 240 | 100 | 100 | 100 |

TABLE B2-4
Sorghum halepense

| | Rate | | Haloxyfop- | Compound |
|---|---|---|---|---|
| Biotype* | (g/ha) | Clethodim | p-methyl | Ic |
| Sensitive | 15 | 83 | 93 | 95 |
| | 30 | 98 | 100 | 97 |
| | 60 | 100 | 100 | 100 |
| | 120 | 93 | 100 | 100 |
| | 240 | 98 | 100 | 100 |
| W2027C | 15 | 50 | 38 | 65 |
| | 30 | 92 | 50 | 80 |
| | 60 | 100 | 68 | 98 |
| | 120 | 100 | 68 | 100 |
| | 240 | 100 | 78 | 100 |

TABLE B2-5
Echinochloa Crus-galli

| | Rate | | Haloxyfop- | Compound |
|---|---|---|---|---|
| Biotype* | (g/ha) | Clethodim | p-methyl | Ic |
| Sensitive | 15 | 100 | 100 | 100 |
| | 30 | 100 | 100 | 100 |
| | 60 | 100 | 100 | 100 |
| | 120 | 100 | 100 | 100 |
| | 240 | 100 | 100 | 100 |
| W2027C | 15 | 83 | 3 | 100 |
| | 30 | 100 | 75 | 100 |
| | 60 | 100 | 73 | 100 |
| | 120 | 100 | 100 | 100 |
| | 240 | 100 | 100 | 100 |
| ECG- | 15 | 95 | 73 | 90 |
| NTSR-1 | | | | |
| | 30 | 98 | 87 | 100 |
| | 60 | 100 | 100 | 100 |
| | 120 | 100 | 100 | 100 |
| | 240 | 100 | 100 | 100 |

1. A method of controlling the growth of monocotyledonous weeds that are resistant to an ACCase-inhibiting herbicide other than a compound of Formula (I) at a locus, said method comprising applying to the locus a herbicide composition comprising a compound of Formula (I) 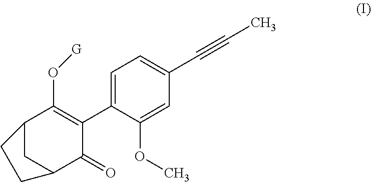
wherein G is selected from the group consisting of hydrogen, —C(O)CH₃ and —C(O)OCH₃.

2. A method according to claim 1, wherein the compound of Formula (I) is selected from the group consisting of Formula (Ia), (Ib) and (Ic).

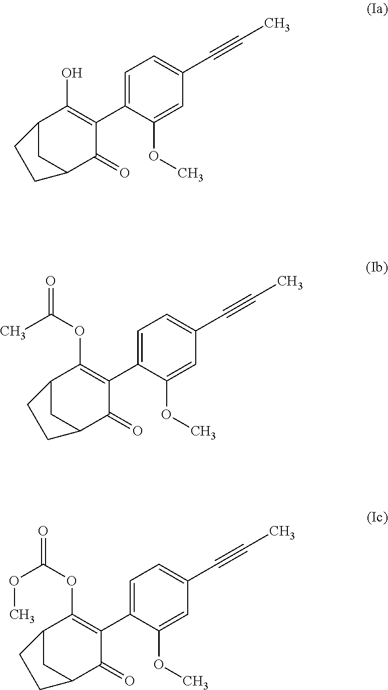

3. A method according to claim 1, wherein the compound of Formula (I) is Formula (Ic).

4. A method according to claim 1, wherein the locus further comprises a dicotyledonous crop plant and wherein said method selectively controls the growth of the monocotyledonous weeds that are resistant to an ACCase-inhibiting herbicide other than a compound of Formula (I) at the locus.

5. A method according to claim 4, wherein the dicotyledonous crop is soybean.

6. A method according to claim 1, wherein the monocotyledonous weeds are resistant to clethodim and/or haloxyfop.

7. A method according to claim 1, wherein monocotyledonous weeds comprise one or more mutations in the ACCase at an amino acid position selected from the group consisting of I1781, W1999, W2027, I2041, D2078, C2088 and G2096.

8. A method according to claim 7, wherein the monocotyledonous weeds comprise one or more mutations in the ACCase at an amino acid position selected from the group consisting of I1781, D2078 and C2088.

9. A method according to claim 1, wherein the monocotyledonous weeds are selected from the group consisting of Alopecurus sp., Avena sp., Bromus sp., Digitaria sp., Echinochloa sp., Ehrharta sp., Eleusine sp., Lolium sp., Phalaris sp., Polypogon sp., Sorghum sp. and Setaria sp.

10. A method according to claim 9, wherein the monocotyledonous weeds are selected from the group consisting of Digitaria insularis, Eleusine indica, Echinochloa crus-galli, Lolium perenne, Lolium multiflorum and/or Sorghum halepense.

11. A method according to claim 1, wherein the monocotyledonous weeds comprise corn which is resistant to fluazifop and/or haloxyfop.

12. A method according to claim 1, wherein the compound of Formula (I) is applied to the locus at a rate of 50 to 500 g/ha.

13. A method according to claim 1, wherein the herbicide composition comprises one or more additional herbicidal compounds.

14. A method according to claim 13, wherein the one or more additional herbicides is selected from the group consisting of glyphosate, glufosinate, 2,4-D, dicamba and S-metolachlor.

15. Use of a compound of Formula (I) 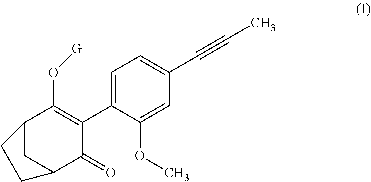
wherein G is selected from the group consisting of hydrogen, —C(O)CH₃ and —C(O)OCH₃, to control monocotyledonous weeds that are resistant to an ACCase-inhibiting herbicide other than a compound of Formula (I).
